(19) United States
(12) Patent Application Publication
(10) Pub. No.: US 2011/0058518 A1
(43) Pub. Date: Mar. 10, 2011

(54) Multi-Channel Single Carrier Per Channel (SCPC) Systems and Related Methods

(75) Inventor: Mark Dale, Scottsdale, AZ (US)

(73) Assignee: COMTECH EF DATA CORP., Tempe, AZ (US)

(21) Appl. No.: 12/877,277

(22) Filed: Sep. 8, 2010

Related U.S. Application Data
(60) Provisional application No. 61/240,969, filed on Sep. 9, 2009.

(51) Int. Cl. H04W 4/00; H04L 12/28; H04J 3/22

(52) U.S. Cl. 370/328; 370/466; 370/395.53

(57) ABSTRACT

A multi-channel demodulating system comprising an analog to digital converter (ADC) that samples an input signal and produces a digital signal, a tuning, filtering, and decimation stage coupled to the ADC and configured to select a transponder based on a frequency range of the digital signal and deliver a signal representative of the digital signal to the transponder, and a demodulator coupled to the selected transponder, a decoder, and the circuit stage, the demodulator configured to receive the representative signal from the transponder, the demodulator and decoder configured to separate and process the representative signal to produce a processed signal. The system further comprises a packet de-encapsulation module coupled to the demodulator and decoder configured to de-encapsulate packets of data contained in the processed signal, a switch coupled to the packet de-encapsulation module and a satellite router, the switch configured to transmit the packets of data to the satellite router.

### CROSS REFERENCE TO RELATED APPLICATIONS

This document claims the benefit of the filing date of U.S. Provisional Patent Application No. 61/240,969, entitled “Multi-Channel Single Carrier Per Channel (SCPC) Systems and Related Methods” to Mark Dale, which was filed on Sep. 9, 2009, the disclosure of which is hereby incorporated entirely by reference herein.

### BACKGROUND

1. Technical Field

Aspects of this document relate generally to telecommunication systems and techniques for transmitting data across a telecommunication channel.

2. Background Art

In single carrier per channel (SCPC) data transmission, each channel available on a satellite transponder utilizes a single carrier signal. Use of SCPC allows allocation of just a portion of the transponder capacity to a particular user (the particular channel which is used for their data).

In a conventional SCPC system, each data channel requires a separate satellite modem at each earth station. In communication architectures where multiple remotes connect to a common Hub, many modems are located in the same physical location. This approach can have space, power and cost disadvantage over alternate solutions. In some communication architectures, remote modems connect directly to the satellite, where on board processing is used to demodulate and modulate the signals. On-board processing has well-known potential advantages in increasing link margin and providing single-hop connectivity between network users. However, with conventional processing approaches, size, weight and power limitations on-board a satellite prohibit the use of traditional SCPC modems that have separate dedicated modems assigned to each channel.

### SUMMARY

Implementations of telecommunication systems like those disclosed in this document may include a multi-channel demodulating system comprising an analog to digital converter (ADC) that samples an input signal and produces a digital signal and a tuning, filtering, and decimation stage coupled to the ADC and configured to select a transponder from a plurality of transponders based on a frequency range of the digital signal and deliver a signal representative of the digital signal to the transponder. The system further comprises a demodulator coupled to the selected transponder, a decoder, and the circuit stage, the demodulator configured to receive the representative signal from the transponder, the demodulator and decoder configured to separate and process the representative signal to produce a processed signal, a packet de-encapsulation module coupled to the demodulator and decoder, and configured to de-encapsulate packets of data contained in the processed signal, and a switch that is coupled to the packet de-encapsulation module and a satellite router, the switch configured to transmit the packets of data to the satellite router.

In some aspects, the tuning, filtering, and decimation stage is further configured to perform Nyquist filtering. The tuning, filtering, and decimation stage may be further configured to perform surface acoustic wave (SAW) filtering. The tuning, filtering, and decimation stage may be further configured to downconvert the representative signal from the transponder to complex baseband. The system may further comprise at least a second demodulator and a second decoder that are arranged in a parallel configuration and configured to separate and process data included in channels within the representative signal received from the transponder. The channel bandwidths may be multiples of a constant multiplicative factor.

The packet de-encapsulation module may be configured to de-encapsulate packets that have been encapsulated using high-level data link control (HDLC). The packets of data may be packets of data that have been encapsulated using multi-protocol encapsulation (MPE) and wherein the packet de-encapsulation module is configured to de-encapsulate the packets that have been encapsulated using multi-protocol encapsulation (MPE). The de-encapsulation module is configured to perform virtual local area network (VLAN) tagging using VLAN tags. The VLAN tags are associated with each channel defined within the transponder. The switch is may be an Ethernet switch.

Some implementations may include a multi-channel modulating system comprising a satellite router that transmits a signal comprising data packets to a switch coupled with a packet encapsulation module configured to encapsulate the data packets and incorporate the encapsulated data packets into a data stream having one or more channels, and a multi-channel encoding and modulation module coupled to the packet encapsulation module and configured to combine the one or more channels of the data stream into a bandwidth of a single output signal. The system further comprises an interpolation module coupled to the multi-channel encoding and modulation module and is configured to interpolate the signal received from the multi-channel encoding and modulation module and upconvert the signal, a filter that is coupled with the interpolation module and is configured to receive the signal from the interpolation module and filter the signal, and a digital-to-analog converter (DAC) that is coupled with the filter and is configured to produce an analog signal that is transmitted to an upconverter.

In some aspects, the data packets include virtual local area network (VLAN) tags, the switch is an Ethernet switch, the interpolation module upconverts the signal from complex baseband to an intermediate frequency (IF), and/or the analog signal produced by the DAC is a low-IF analog signal.

Some implementations may include a method of transmitting data using a multi-channel demodulating system, the method comprising sampling an input signal and producing a digital signal using an analog to digital converter (ADC), selecting a transponder from a plurality of transponders based on a frequency range of the digital signal using a tuner, a filter, and a decimator that are coupled together to form a circuit stage, and separating and processing the digital signal with a demodulator and a decoder coupled to the transponder after it is passed through the transponder. The method further comprises de-encapsulating packets of data contained in the processed digital signal received from the decoder using a packet de-encapsulation module coupled to the demodulator and decoder, and transmitting the de-encapsulated packets of data to a satellite router through a switch coupled between the packet de-encapsulation module and the satellite router.

In some aspects, the method further comprises Nyquist filtering the digital signal at the circuit stage with the filter, surface acoustic wave (SAW) filtering the digital signal at the circuit stage with the filter, and/or downconverting the digital signal at the circuit stage to complex baseband using the tuner, filter, and decimator. The method may further comprise separating and processing data included in channels within the signal received from the transponder using at least a second demodulator and a second decoder arranged in a parallel configuration.

In some aspects, the channel bandwidths are multiples of a constant multiplicative factor. The method may further comprise de-encapsulating packets that have been encapsulated using high-level data link control (HDLC) at the packet de-encapsulation module, de-encapsulating packets that have been encapsulated using multi-protocol encapsulation (MPE) at the packet de-encapsulation module, and/or performing virtual local area network (VLAN) tagging using the de-encapsulation module is configured to perform virtual local area network (VLAN) tagging using VLAN tags. The VLAN tags may be associated with each channel defined within the transponder and the switch may be an Ethernet switch.

Some implementations may include a method of transmitting data using a multi-channel modulating system, the method comprising transmitting a signal to a switch that is coupled with a packet encapsulation module using a satellite router, the signal comprising data packets, encapsulating the data packets using the packet encapsulation module and incorporating the encapsulated data packets into a data stream having one or more channels, and combining the one or more channels of the data stream into a bandwidth of a single output signal using a multi-channel encoding and modulation module that is coupled to the packet encapsulation module. The method further comprises interpolating the signal received from the multi-channel encoding and modulation module and upconverting the signal using an interpolation module that is coupled to the multi-channel encoding and modulation module, receiving the signal from the interpolation module and filtering the signal using a filter that is coupled with the interpolation module, and producing an analog signal that is transmitted to an upconverter using a digital-to-analog converter (DAC) that is coupled with the filter.

In some aspects, the data packets include virtual local area network (VLAN) tags, the switch is an Ethernet switch, and/or the analog signal produced by the DAC is a low-IF analog signal. The method may further comprise upconverting the signal from complex baseband to an intermediate frequency (IF) using the interpolation module.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶ 6. Thus, the use of the words “function,” “means” or “step” in the Description, Drawings, or Claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶ 6. Moreover, even if the provisions of 35 U.S.C. §112, ¶ 6 are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 depicts an implementation of a multi-channel single carrier per channel (MCSCPC) system.

FIG. 2 depicts an implementation of a multi-channel demodulator that may be used in an MCSCPC system.

FIGS. 3-4 depict different examples of possible channel bandwidths.

FIG. 5 depicts an implementation of a multi-channel modulator (MCM).

FIG. 6 depicts a method of processing data using a multi-channel single carrier per channel (MCSCPC) system.

FIG. 7 depicts a method of receiving data using a multi-channel demodulating system.

FIG. 8 depicts a method of transmitting data using a multi-channel modulating system.

### DESCRIPTION

This disclosure, its aspects and implementations, are not limited to the specific components or assembly procedures disclosed herein. Many additional components and assembly procedures known in the art consistent with the intended telecommunication system components and/or assembly procedures for telecommunication system components will become apparent for use with particular implementations from this disclosure. Accordingly, for example, although particular implementations are disclosed, such implementations and implementing components may comprise any shape, size, style, type, model, version, measurement, concentration, material, quantity, and/or the like as is known in the art for such telecommunication systems and implementing components, consistent with the intended operation.

Implementations of multi-channel single carrier per channel (“MCSCPC”) systems like those disclosed in this document enable the processing and routing of signals being received from multiple channels on multiple transponders on a single satellite. Because the routing may be performed on the satellite itself, implementations of MCSCPC systems like those disclosed may enable routing in space applications that permit data transport using packets over a satellite network. While particular implementations are disclosed in which the processing takes place on a satellite, the principles disclosed in this document may be used to process and route signals in any of a wide variety of other telecommunication systems that utilize a multi-channel multi-receiver environment, such as, by non-limiting example, terrestrial wireless hub/spoke systems, cellular telephone communication systems, microwave communication systems, and other telecommunication system types. When implemented in a satellite telecommunication system, the architecture of implementations of MCSCPC systems like those disclosed may combine the benefits of regenerative links and single-hop mesh connectivity with the optimal efficiencies inherent in the SCPC physical layer for constant data rate communication links. In addition, a minimal amount of hardware and power may need to be utilized in implementations of MCSCPC systems like those disclosed while providing a large and highly configurable number of SCPC connections to an on-board satellite router.

Referring now to FIG. 1, as illustrated, a downconverter (D/C) module 10 is used to downconvert the received signals to a low intermediate frequency (IF) range. Depending upon the particular downconverter module 10 being used, any of the conventional radio frequency (RF) satellite frequencies could be processed by MCSCPC systems like those disclosed in this document. These could include L, S, C, X, Ku, K, Ka, V, W, or any other frequency band. The downconverted signals are then received by one or more multi-channel demodulators 20 (MCDs) which are each paired with a particular transponder 30. While terrestrial downconverters typically employ a fixed (block) conversion from the RF satellite frequency to L-band, followed by a tunable downconversion from L-band to complex base band, in various implementations of MCSCPC systems, the second stage conversion (L-band to low IF) could also be fixed. The third tunable downconversion from low-IF to complex baseband may be accomplished digitally within the MCDs.

As illustrated by the example provided in FIG. 1, a satellite router 40 is then used to route the signals to one or more multi-channel modulators 50 which are each paired with a particular transponder 30 and passed to an upconverter (U/C) module 60. Implementations of satellite routers may perform functions and/or operate in ways similar to or identical with terrestrial routers. In particular implementations of MCSCPC systems, because the traffic assigned to a given port may be unidirectional, all the traffic received may be received on a first port and then transmitted on a second port different from the first port. While this functionality differs from conventional bidirectional links, conventional router implementations may be capable of supporting such a unidirectional configuration.

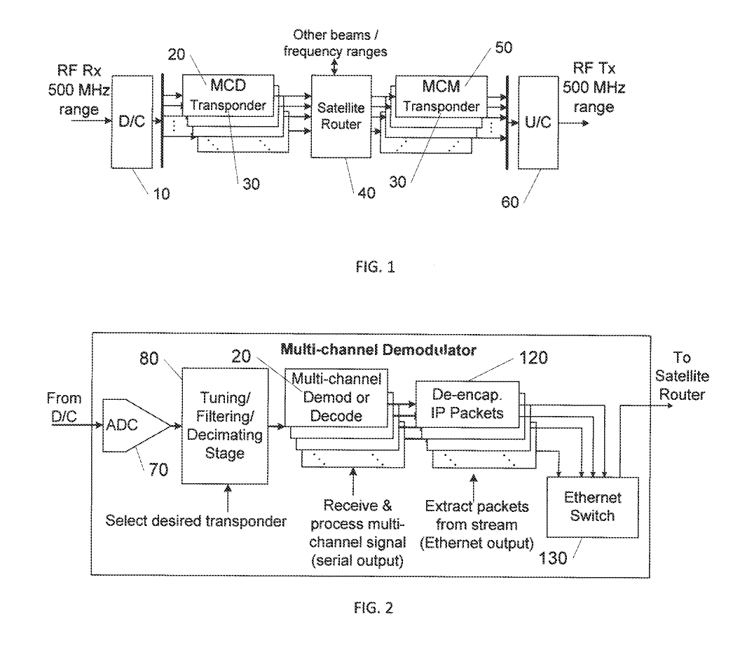

As illustrated by the example provided in FIG. 2, the multi-channel demodulator (MCD) 20 includes a high speed analog-to-digital converter (ADC) 70 that samples the input signal and produces a digital signal which is received by a stage that tunes, filters and decimates, the stage 80 having a tuner, filter, and decimator, that selects the desired transponder 30 from within the selected frequency range. The tuning/filtering/decimating stage 80 may then digitally downconvert the transponder signal to complex baseband while performing various filtering and decimation operations (such as, but not limited to, Nyquist filtering and or surface acoustic wave (SAW) filtering) to reduce subsequent processing requirements. Within the MCD 20 are one or more demodulation and one or more decoding stages arranged in parallel configurations and adapted to successively separate and process the data included in each of the channels contained within the transponder signal. Examples of systems and methods that may be utilized to perform the separation and processing of the data may be found in U.S. Pat. No. 6,907,083 to John Lillington entitled “Frequency Analysis,” issued Jun. 14, 2005; and U.S. Provisional Patent No. 61/138,196 to Cannon et al., entitled “Multi-Beam, Multi-Channel Burst Processing Modem,” filed Dec. 17, 2008, the disclosures of which are hereby incorporated entirely herein by reference.

Additionally, a packet de-encapsulation module 120 is included in implementations of MCDs 20. The packet de-encapsulation module 120 may be adapted to de-encapsulate packets that have been encapsulated using any of a wide variety of conventional encapsulation methods, such as, by non-limiting example, high-level data link control (HDLC) used for point-to-point synchronous data streams, multi-protocol encapsulation (MPE) used for internet protocol (IP) and other encapsulations in systems supporting the digital video broadcast (DVB) standards which includes DVB-S and DVB-S2, and DVB-S2 generic stream used as an alternative mechanism for sending traffic (including IP packets) in the DVB-S2 standard. A wide variety of proprietary encapsulation methods may also be used, such as, by non-limiting example, the encapsulation methods disclosed in co-pending, co-owned U.S. patent application Ser. No. 12/398,855 to John Ehlers, entitled “Data Packet Encapsulation Methods,” filed Mar. 5, 2009, the disclosure of which is hereby incorporated entirely herein by reference.

Implementations of packet de-encapsulation modules may also add Ethernet framing and may also perform virtual local area network (VLAN) tagging. In implementations utilizing VLAN tagging, the VLAN tags could be associated with each SCPC channel defined within the transponder, which would provide the router a mechanism to establish VLANs for desired sets of SCPC connections to the satellite.

The de-encapsulated packets are then received by an Ethernet or other switch module 130. Implementations of the switch module 130 may support the use of the VLAN tags to perform routing or they may forward packets received from all SCPC connections within a given transponder 30 to the satellite router 40 (see FIG. 1) using a single high-speed Ethernet connection.

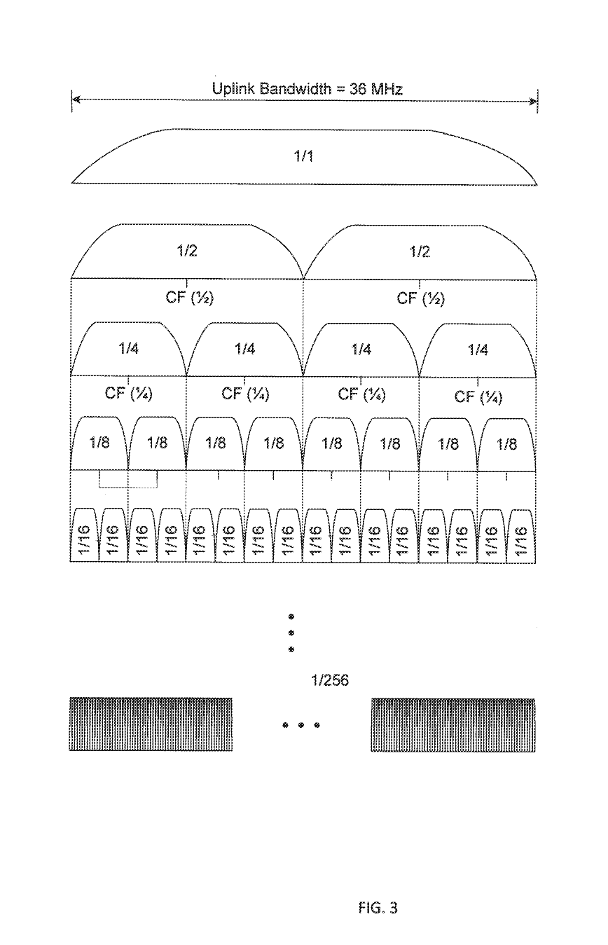

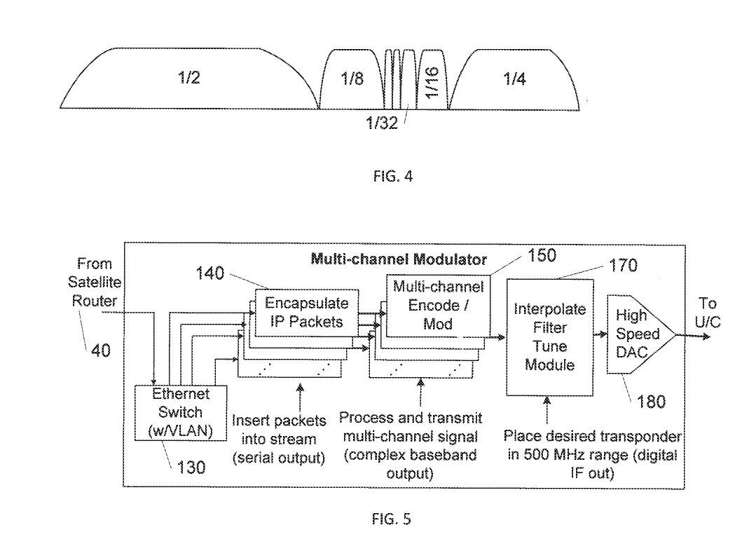

The potential bandwidths that may be separated and processed may be a mixture of signal bandwidths in powers of two or other factors, such as, 3, 4, etc. For example, starting from a single channel the size of the entire processed spectrum, possible channel sizes include, by non-limiting example, single channel, ½, ¼, ⅛, 1/16, 1/32, 1/64, 1/128 and 1/256 width channels as shown in FIG. 3. An additional example of another valid possible set of channelized bandwidths is illustrated in FIG. 4.

In various particular implementations of MCSCPC systems like those disclosed, processing resource requirements may scale with the total symbol rate processed (e.g. demodulation functions). In other particular implementations, the processing resource requirements may scale with the total processed bit rate (e.g. decoding functions). However, for a given modulation and forward error correction mode, the total processing requirements for an entire transponder may be roughly the same regardless of how the transponder is channelized. For example, the processing requirements for a carrier that occupies an entire 36 MHz transponder may be roughly the same as one signal occupying 18 MHz plus two more occupying 9 MHz, or 5 occupying 3.6 MHz plus 10 occupying 1.8 MHz. Hence, in various implementations, the demodulation/decoding resource requirements necessary to process each supported transponder may be roughly equivalent to the demodulation/decoding resource requirements in a single high-speed commercial SCPC modem, regardless of how the transponder is channelized.

A wide variety of open standards and modes commonly used in the satellite industry may be supported and utilized in implementations of MCSCPC systems to maximize the number of government and commercial SCPC modems that would be compatible with the systems. A non-limiting example of a list of such conventional and proprietary systems is included in Table 1:

TABLE 1

| Mode/Standard | Comment |
|---|---|
| IESS-308 | Intelsat standard, QPSK & Viterbi, Viterbi-RS |
| IESS-309 | Intelsat standard, QPSK & Viterbi, Viterbi-RS |
| IESS-310 | Intelsat standard, 8PSK & TCM, TCM-RS |
| IESS-315 | Intelsat standard, QPSK & Turbo FEC |
| MIL-STD-188-165A | Extension to IESS-308, 309 & 310. Required for many government links. |
| MIL-STD-188-165B | Future Government standard |
| DVB-S | Used as shared carrier for ISP trunking applications |
| DVB-S2 | Professional Services profile (QPSK, 8PSK, 16/32 APSK, all block |
| | sizes & code rates). Important current and future standard. |
| Commercial Proprietary | Supports all modes of common commercial and government modems |
| | (i.e., Comtech EF Data's CDM-570, 600, 625, SLM-3650, 5650, 7650, 8650). |

Implementations of multi-channel demodulators (MCDs) may also support AES-256 bulk decryption, designed in compliance with FIPS-140-2 requirements. This feature may allow TRANSEC and/or Type 1 TRANSEC to be optionally supported by implementations of MCSCPC systems like those disclosed, which may be important for many current and future government applications.

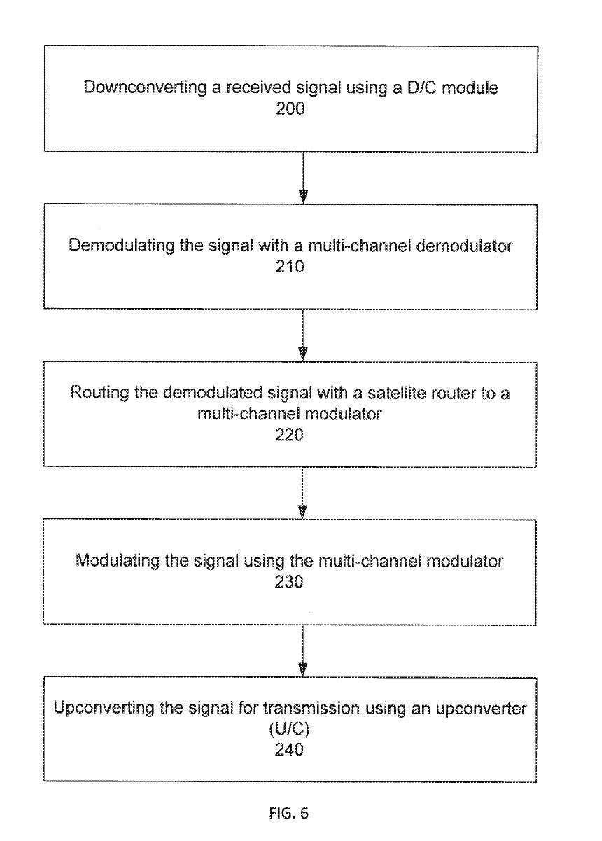

Referring to the example provided in FIG. 5, which depicts an implementation of a multi-channel modulator (MCM) 50, as illustrated, implementations of MCMs 50 may receive data packets from the satellite router 40 with an Ethernet or other switch module 130. Particular implementations may utilize data packets that include VLAN tags. The Ethernet or other switch module 130 may then transmit the packets to a packet encapsulation module 140, which may utilize any of the encapsulation techniques previously disclosed in this document to encapsulate the data packets.

Once the data packets have been encapsulated and incorporated into a data stream, a multi-channel encoding and modulation (combiner) module 150 is used to combine each of the one or more channels to which the data in the data stream corresponds into the bandwidth of a single output signal. Any of a wide variety of methods may be used to perform the combination, including, by non-limiting example, the methods disclosed in U.S. Provisional Patent No. 61/138,196 to Cannon et al. previously incorporated by reference; and the methods disclosed in co-pending, co-owned U.S. patent application Ser. No. 12/552,576 to Crockett, entitled “Combiner System and Related Methods,” filed Sep. 2, 2009, the disclosure of which is incorporated herein entirely by reference. In particular implementations, a plurality of frequency combining stages and encoding stages may be employed which may be compatible and interoperable with the demodulating stages and decoding stages previously disclosed in this document. In various implementations, as in implementations of the MCDs, the total processing requirement may be independent of how the channelization is done on the transponder. Also, any of the commercial, government, and proprietary standards disclosed in this document may be implemented in various implementations, including TRANSEC.

The output signal from the combiner module is received by an interpolate/filter/tune module (interpolation module) 170 that interpolates the desired signal to a data rate that supports the desired IF range. The resulting digital transponder signal is then digitally up converted from complex baseband to the desired IF frequency and filtered (e.g. x/sin(x) or other filtering techniques) for input to the digital-to-analog converter (DAC) 180. The DAC 180 accepts the digital samples and produces a low-IF analog signal which is then upconverted using an upconverter (U/C) 60 to the desired RF satellite frequency range, which may be any disclosed in this document. The exact IF range may vary by implementation; a non-limiting example of an IF range is 50 to 550 MHz. The upconverter 60 may utilize one or more fixed upconversion stages.

Referring now to FIG. 6, which discloses an implementation of a method of processing data using an MCSCPC system, a received signal is downconverted by a downconverter module 200. The signal is then demodulated using a multi-channel demodulator that is coupled to the downconverter and a first transponder 210. A satellite router then routes the demodulated signal to a multichannel modulator that is coupled to a second transponder 220. The signal is then modulated by the multi-channel modulator 230 and upconverted for transmission by an upconverter (U/C) module 240.

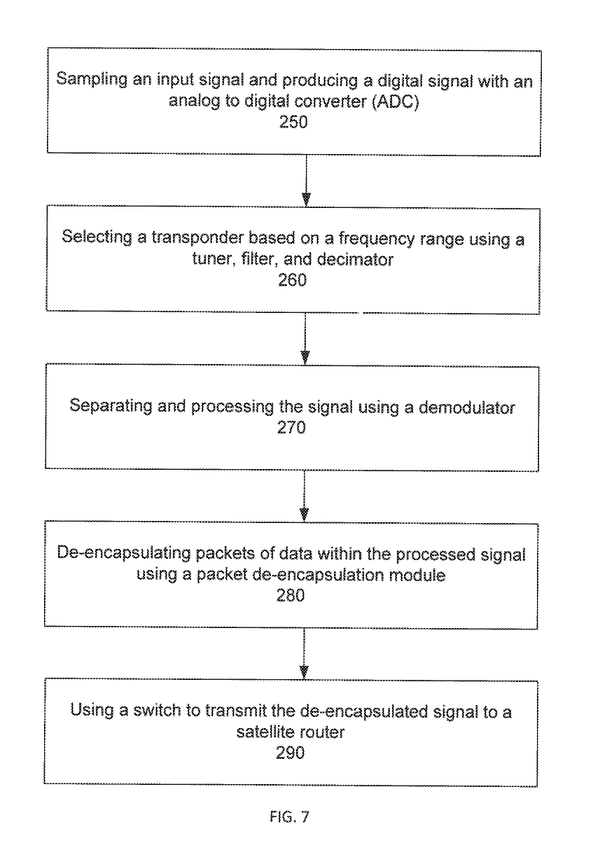

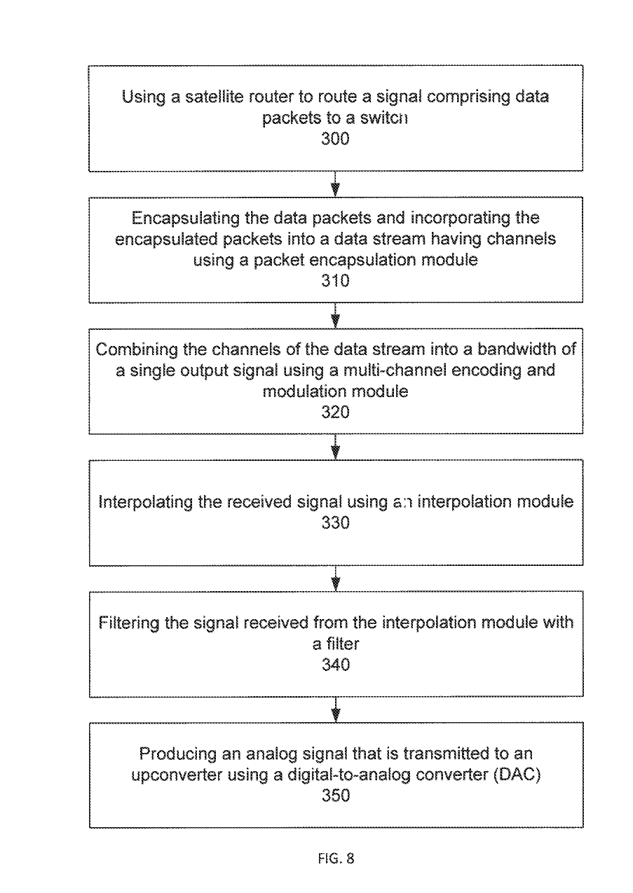

FIG. 7 depicts an implementation of a method receiving data using a multi-channel demodulating system. An analog to digital converter (ADC) is used to sample an input signal and produce a digital signal 250. A tuner, filter and decimator are then used to select a transponder based on the frequency range of the digital signal 260. The signal is then separated and processed by a demodulator 270 and a packet de-encapsulation module is used to de-encapsulate packets of data within the processed signal 280. A switch, which may be, but is not limited to an Ethernet switch, is then used to transmit the signal to a satellite router 290.

FIG. 8 depicts an implementation of a method of transmitting data using a multi-channel modulating system. A signal having data packets within is transmitted from a satellite router through a switch and to a packet encapsulation module 300 where the data packets are encapsulated and incorporated into a data stream that has one or more channels 310. The channels of the data stream are combined into a bandwidth of a single output signal using a multi-channel encoding and modulation module 320. The signal is then interpolated and upconverted by an interpolation module that is coupled to the multi-channel encoding and modulation module 330. A filter then filters the signal 340 and a digital-to-analog converter (DAC) is used to produce an analog signal which is transmitted to an upconverter 350.

The materials used for implementations of MCSCPC systems like those disclosed in this document may be made of conventional materials used to make goods similar to these in the art, such as, by non-limiting example, metals, plastics, semiconductors, rubbers, composites, and the like. Those of ordinary skill in the art will readily be able to select appropriate materials and manufacture these products from the disclosures provided herein.

The implementations listed here, and many others, will become readily apparent from this disclosure. From this, those of ordinary skill in the art will readily understand the versatility with which this disclosure may be applied.

In places where the description above refers to particular implementations of MCSCPC systems and methods, it should be readily apparent that a number of modifications may be made without departing from the spirit thereof and that these implementations may be applied to other MCSCPC implementations.

1. A multi-channel demodulating system comprising:
an analog to digital converter (ADC) that samples an input signal and produces a digital signal;
a tuning, filtering, and decimation stage coupled to the ADC and configured to select a transponder from a plurality of transponders based on a frequency range of the digital signal and deliver a signal representative of the digital signal to the transponder;
a demodulator coupled to the selected transponder, a decoder, and the circuit stage, the demodulator configured to receive the representative signal from the transponder, the demodulator and decoder configured to separate and process the representative signal to produce a processed signal;
a packet de-encapsulation module coupled to the demodulator and decoder, and configured to de-encapsulate packets of data contained in the processed signal; and
a switch that is coupled to the packet de-encapsulation module and a satellite router, the switch configured to transmit the packets of data to the satellite router.

2. The system of claim 1, wherein the tuning, filtering, and decimation stage is further configured to perform Nyquist filtering.

3. The system of claim 1, wherein the tuning, filtering, and decimation stage is further configured to perform surface acoustic wave (SAW) filtering.

4. The system of claim 1, wherein the tuning, filtering, and decimation stage is further configured to downconvert the representative signal from the transponder to complex baseband.

5. The system of claim 1, further comprising at least a second demodulator and a second decoder that are arranged in a parallel configuration and configured to separate and process data included in channels within the representative signal received from the transponder.

6. The system of claim 5, wherein channel bandwidths are multiples of a constant multiplicative factor.

7. The system of claim 1 wherein the packet de-encapsulation module is configured to de-encapsulate packets that have been encapsulated using high-level data link control (HDLC).

8. The system of claim 1, wherein the packets of data are packets of data that have been encapsulated using multi-protocol encapsulation (MPE) and wherein the packet de-encapsulation module is configured to de-encapsulate the packets that have been encapsulated using multi-protocol encapsulation (MPE).

9. The system of claim 1, wherein the de-encapsulation module is configured to perform virtual local area network (VLAN) tagging using VLAN tags.

10. The system of claim 9, wherein the VLAN tags are associated with each channel defined within the transponder.

11. The system of claim 1, wherein the switch is an Ethernet switch.

12. A multi-channel modulating system comprising:
a satellite router that transmits a signal comprising data packets to a switch coupled with a packet encapsulation module configured to encapsulate the data packets and incorporate the encapsulated data packets into a data stream having one or more channels;
a multi-channel encoding and modulation module coupled to the packet encapsulation module and configured to combine the one or more channels of the data stream into a bandwidth of a single output signal;
an interpolation module coupled to the multi-channel encoding and modulation module and is configured to interpolate the signal received from the multi-channel encoding and modulation module and upconvert the signal;
a filter that is coupled with the interpolation module and is configured to receive the signal from the interpolation module and filter the signal; and
a digital-to-analog converter (DAC) that is coupled with the filter and is configured to produce an analog signal that is transmitted to an upconverter.

13. The system of claim 12 wherein the data packets include virtual local area network (VLAN) tags.

14. The system of claim 12 wherein the switch is an Ethernet switch.

15. The system of claim 12 wherein the interpolation module upconverts the signal from complex baseband to an intermediate frequency (IF).

16. The system of claim 12 wherein the analog signal produced by the DAC is a low-IF analog signal.

17. A method of transmitting data using a multi-channel demodulating system, the method comprising:
sampling an input signal and producing a digital signal using an analog to digital converter (ADC);
selecting a transponder from a plurality of transponders based on a frequency range of the digital signal using a tuner, a filter, and a decimator that are coupled together to form a circuit stage;
separating and processing the digital signal with a demodulator and a decoder coupled to the transponder after it is passed through the transponder;
de-encapsulating packets of data contained in the processed digital signal received from the decoder using a packet de-encapsulation module coupled to the demodulator and decoder; and
transmitting the de-encapsulated packets of data to a satellite router through a switch coupled between the packet de-encapsulation module and the satellite router.

18. The method of claim 17, further comprising Nyquist filtering the digital signal at the circuit stage with the filter.

19. The method of claim 17, further comprising surface acoustic wave (SAW) filtering the digital signal at the circuit stage with the filter.

20. The method of claim 17, further comprising downconverting the digital signal at the circuit stage to complex baseband using the tuner, filter, and decimator.

21. The method of claim 17, further comprising separating and processing data included in channels within the signal received from the transponder using at least a second demodulator and a second decoder arranged in a parallel configuration.

22. The method of claim 21, wherein channel bandwidths are multiples of a constant multiplicative factor.

23. The method of claim 17, further comprising de-encapsulating packets that have been encapsulated using high-level data link control (HDLC) at the packet de-encapsulation module.

24. The method of claim 17, further comprising de-encapsulating packets that have been encapsulated using multi-protocol encapsulation (MPE) at the packet de-encapsulation module.

25. The method of claim 17, further comprising performing virtual local area network (VLAN) tagging using the de-encapsulation module is configured to perform virtual local area network (VLAN) tagging using VLAN tags.

26. The method of claim 25, wherein the VLAN tags are associated with each channel defined within the transponder.

27. The method of claim 17, wherein the switch is an Ethernet switch.

28. A method of transmitting data using a multi-channel modulating system, the method comprising:
transmitting a signal to a switch that is coupled with a packet encapsulation module using a satellite router, the signal comprising data packets;
encapsulating the data packets using the packet encapsulation module and incorporating the encapsulated data packets into a data stream having one or more channels;
combining the one or more channels of the data stream into a bandwidth of a single output signal using a multi-channel encoding and modulation module that is coupled to the packet encapsulation module;
interpolating the signal received from the multi-channel encoding and modulation module and upconverting the signal using an interpolation module that is coupled to the multi-channel encoding and modulation module;
receiving the signal from the interpolation module and filtering the signal using a filter that is coupled with the interpolation module; and
producing an analog signal that is transmitted to an upconverter using a digital-to-analog converter (DAC) that is coupled with the filter.

29. The system of claim 28, wherein the data packets include virtual local area network (VLAN) tags.

30. The system of claim 28, wherein the switch is an Ethernet switch.

31. The system of claim 28, further comprising upconverting the signal from complex baseband to an intermediate frequency (IF) using the interpolation module.

32. The system of claim 28, wherein the analog signal produced by the DAC is a low-IF analog signal.
